(19) United States
(12) Patent Application Publication
(10) Pub. No.: US 2026/0162158 A1
(43) Pub. Date: Jun. 11, 2026

(54) System and method for autonomous real-time cost calculation of manufacturing costs through a multimodal neural network integrated into wearable, mounted, or embedded mixed-reality devices

(71) Applicants: Buenyamin Soezer, Esslingen (DE); Zeki Soezer, Esslingen (DE)

(72) Inventors: Buenyamin Soezer, Esslingen (DE); Zeki Soezer, Esslingen (DE)

(21) Appl. No.: 19/356,524

(22) Filed: Oct. 13, 2025

Related U.S. Application Data
(60) Provisional application No. 63/706,677, filed on Oct. 13, 2024.

(51) Int. Cl. G06Q 30/0283; G06Q 10/0631; G06Q 50/04; G06T 19/00

(52) U.S. Cl. CPC G06Q 30/0283; G06Q 10/06313; G06Q 50/04; G06T 19/006

(57) ABSTRACT

A system and method for autonomous, real-time calculation of manufacturing costs are disclosed. The system is deployed in head-mounted displays, body-mounted displays, robot-integrated, or drone-mounted interfaces. It comprises an input and acquisition module configured to capture multimodal technical data including visual sketches, spoken descriptions, gestures, and sensor signals. A synchronization and alignment module temporally and spatially aligns the inputs. A multimodal neural-network engine processes the aligned data through dedicated vision, language, and sensor branches, followed by cross-modality fusion and inference. Extracted technical parameters include geometry, material weight and density, tolerances, cavity configuration, manufacturing method, production volume, labor factors, and environmental conditions. A cost-calculation module generates real-time cost values, which are delivered via visualization, audio, or structured digital export. An adaptive learning module refines calculations based on feedback, environmental data, and corrected physical parameters. The system enables early-phase cost transparency without reliance on CAD, BOM, or database resources.

### CROSS-REFERENCE TO RELATED APPLICATIONS

This application claims the benefit of U.S. Provisional Ser. No. 63/706,677, filed on Oct. 13, 2024, the entire contents of which are hereby incorporated by reference.

### FIELD OF THE INVENTION

The invention relates to systems and methods for autonomous, real-time manufacturing cost calculation using multimodal data acquisition and neural-network-based analysis. More particularly, the invention concerns a cost-determination architecture executable within head-mounted and body-mounted displays and integrable through robot-mounted and drone-mounted interfaces operating in mixed-reality (MR), virtual-reality (VR), or augmented-reality (AR) environments, enabling visual, linguistic, and sensor-based processing of technical information to generate manufacturing-cost data without reliance on pre-existing structured datasets such as computer-aided design (CAD) models, bills of materials (BOM), or other data sources.

### BACKGROUND OF THE INVENTION

Conventional approaches to manufacturing cost calculation rely on pre-existing structured data such as computer-aided design (CAD) models, bills of materials (BOM), or databases containing part-and material-specific cost rates. Comparative or parametric cost models adjust stored values based on geometric or material similarity. Preparation of such databases is labor-intensive; technical information, including geometry, raw-material data, manufacturing-process data, and cost-relevant parameters, must be compiled manually by experts. Data collection, aggregation, analysis, and cost calculation remain predominantly semi-manual; relying on spreadsheet-based or database-supported tools, these methods are time-consuming, particularly in early development phases when structured technical information is incomplete or unavailable. Where structured data are absent, calculations are performed by specialists are error-prone due to subjective interpretation and limited process understanding. Manual or expert-based cost calculation introduces subjectivity and inconsistent results, often leading to deviations in financial and design decisions. Insufficient standardization and inconsistent understanding of manufacturing processes often lead to inaccuracies in technical assessment. False assumptions regarding material or process parameters and misclassification of labor and machine factors result in incorrect make-or-buy decisions and financial deviations. Manual input of unstructured information (e.g., sketches, spoken descriptions, or sensor readings) is not supported. Database-driven models embed historical assumptions regarding materials, processes, and labor structures and lack adaptability to novel designs. Two-dimensional drawings, when available, provide only limited geometric information without full three-dimensional feature data, process details, or subcomponent structure; such drawings are typically unavailable in early phases. Manual, semi-manual and automated extraction and transfer of technical data from 2D drawings into enterprise systems, such as ERP or PLM platforms in case of availability, are error-prone and cause precision loss and inconsistent results. Existing methods provide no systematic capability for assemblies with multiple subcomponents without time-consuming manual decomposition. During manufacturing operations, no system enables continuous or real-time cost calculation synchronized with physical production; available computational environments provide only post-process evaluations based on recorded data rather than live process information. Hardware configurations such as head-mounted displays (HMDs), body-mounted displays (BMDs), and robot-integrated or drone-mounted interfaces lack the multimodal sensing, alignment, and inference mechanisms required for autonomous real-time cost determination.

### SUMMARY OF THE INVENTION

The invention eliminates dependence on structured datasets and manual and semi manual cost calculation by directly interpreting unstructured, multimodal technical input through a neural-network-based system capable of adaptive inference and cross-modal learning. This transforms manufacturing-cost calculation into an autonomous, real-time process. Unlike database-driven or manually executed methods, the invention operates without reliance on CAD data, BOM data, or other structured data sources; it directly processes multimodal inputs, dynamically adapts to user interaction, and extends applicability to assemblies consisting of subcomponents. [0005] By avoiding database dependency and manual estimation, the invention provides early-stage and continuous cost-calculation capability throughout the entire product lifecycle. [0006] The invention provides a system and method for autonomous, real-time calculation of manufacturing costs without reliance on pre-existing structured datasets such as computer-aided design (CAD) models, bills of materials (BOM), or database-based cost tables. [0007] The system acquires multimodal, unstructured input including sketches, spoken technical descriptions, gestures, and sensor signals through wearable, mounted, or embedded devices. Deployment environments include head-mounted displays (HMD), body-mounted displays (BMD), robot-integrated systems, and drone-mounted interfaces operating in mixed-reality (MR), virtual-reality (VR), or augmented-reality (AR) environments. [0008] The acquired data are temporally aligned using synchronization methods and spatially mapped into a shared coordinate system. A multimodal neural network processes the inputs through dedicated branches for visual, linguistic, and sensor data. Cross-modality integration generates unified technical representations from which cost-relevant parameters are extracted, including geometry, material type and properties such as weight, density, tolerances, functional indicators, manufacturing method, cavity configuration, and production volume. [0009] Extracted parameters are transformed into cost-driving factors and real-time manufacturing-cost values. Results are delivered as visual overlays in MR, VR, or AR environments, as audible feedback, or as structured digital output for optional integration into enterprise systems. [0010] The invention enables design-to-cost analysis, production monitoring and provides continuous and adaptive cost transparency throughout all stages of the product lifecycle.

As used herein, the term “cost calculation” shall be understood to include cost estimation and cost evaluation processes performed by analytical, inferential, or neural network based methods, unless explicitly stated otherwise.

### BRIEF DESCRIPTION OF THE DRAWINGS

FIG. 1 illustrates the overall system architecture (100) showing deployment environments including head-mounted, body-mounted, robot-mounted, and drone-mounted interfaces.

FIG. 1A illustrates system components (100) in hierarchical structure corresponding to the modular system layout.

FIG. 2 illustrates a process flow (200) of he system for autonomous real-time manufacturing cost calculation.

FIG. 3 illustrates a process monitoring workflow (300) of the system for real-time recalculation and adaptive cost calculation during manufacturing.

FIG. 4 illustrates the neural-network architecture (400) comprising visual, language, and sensor modules including fusion, inference, and adaptive-learning mechanisms.

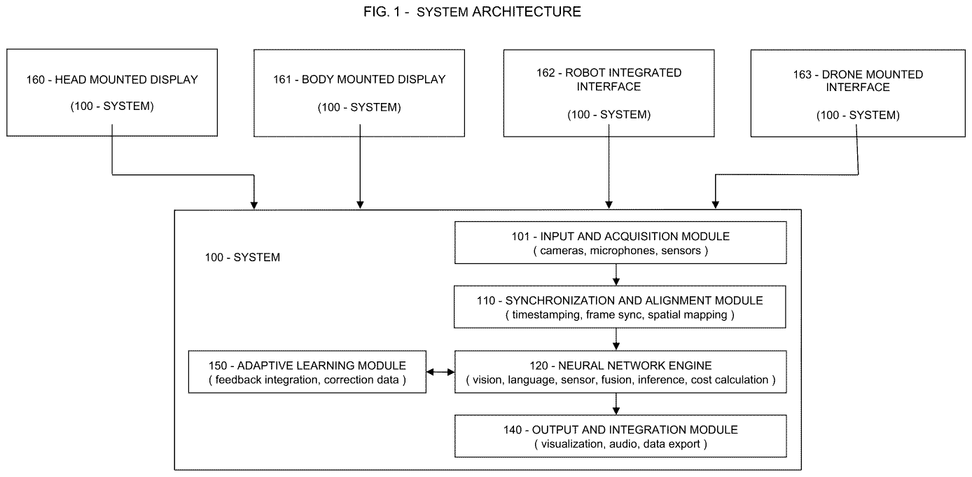

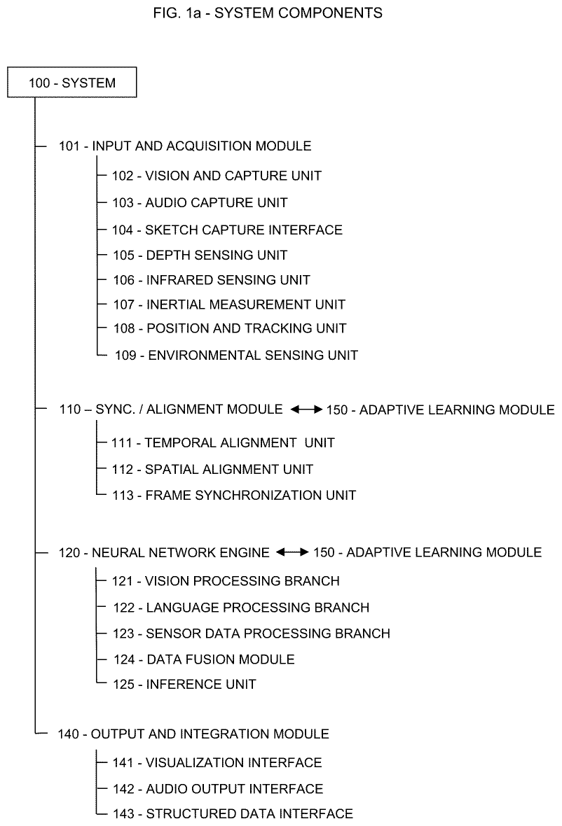

### DETAILED DESCRIPTION OF FIG. 1 AND FIG. 1A

### System Architecture and Components

In one embodiment, the invention provides a modular system (100) designed for deployment across multiple platforms, including a head-mounted display (160), a body-mounted display (161), a robot-integrated interface (162), and a drone-mounted interface (163). Within each deployment, the system executes the complete real-time cost-calculation process by integrating perception, alignment, inference, and visualization within a unified architecture. [0017] The system (100) comprises a sequence of functionally interlinked modules configured to acquire, synchronize, and interpret multimodal information streams to transform them into cost data. An input and acquisition module (101) initiates the process by capturing raw, unstructured multimodal input from the user's physical and digital environment. The vision and capture unit (102)—including an RGB camera, depth sensors, and an inertial measurement unit—captures hand drawn sketches and geometric features drived from gesture movement within the mixed-reality environment. An audio capture unit (103) records spoken technical descriptions. A sketch-capture interface (104) enables gesture-based design input, and a depth-sensing unit (105) acquires three-dimensional geometric data. An infrared-sensing unit (106) detects surface features and emissivity. An inertial measurement unit (107) detects movement and orientation, while a position and tracking unit (108) maintains spatial awareness. An environmental-sensing unit (109) measures ambient parameters such as temperature, humidity, material density, reflectance, and surface characteristics.

Once acquired, the multimodal signals are processed by a synchronization and alignment module (110), which temporally and spatially aligns all data streams. The module includes a temporal alignment unit (111), a spatial alignment unit (112), and a frame synchronization unit (113). The spatial alignment unit (112) performs simultaneous localization and mapping (SLAM) based on combined sensor and inertial data, generating a unified coordinate frame shared across all modalities. This ensures that spoken, visual, and sensor-based elements are correlated with the same spatial and temporal reference. [0019] Aligned data are then forwarded to the neural-network engine (120), which performs multimodal feature encoding across three parallel branches: a vision-processing branch (121), a language-processing branch (122), and a sensor-data-processing branch (123). The outputs of these branches are merged by a data-fusion module (124) into a unified multimodal representation. The inference unit (125) derives cost-relevant parameters including geometry, material weight and density, tolerances, manufacturing method, and production volume. Internal weighting adjustments, implemented through the adaptive learning module (150) and the feedback mechanisms of the neural-network architecture (400), enable continuous refinement of parameter weighting and estimation accuracy as new multimodal inputs are received. [0020] The generated results are transmitted to the output and integration module (140). This module provides multimodal feedback through a visualization interface (141) operating in mixed-, virtual-, or augmented-reality (MR/VR/AR) environments, an audio output interface (142), and a structured data interface (143). The visualization enables real-time overlays of manufacturing feedback within the user's field of view, while the structured data interface (143) allows integration into enterprise or manufacturing-execution systems. [0021] Throughout operation, the adaptive learning module (150) monitors the accuracy of synchronization and inference. By comparing system outputs with observed conditions, it continuously refines neural-network parameters and physical calibration, adapting the system to deviations in sensor input or environmental dynamics. [0022] All modules (101-150) collectively constitute the system (100), functioning as an integrated cost-calculation engine deployable across the platforms (160-163). In practical operation, the head- and body-mounted displays (160,161) provide direct human interaction trough visual and tactile layers, whereas the robot- and drone-mounted interfaces (162, 163) facilitate platform integration with machine signals, pose tracking, and environmental telemetry. [0023] Each deployment hosts the complete system (100), enabling autonomous operation within its respective environment. The displays (160, 161) emphasize interactive, user-facing overlays and voice-driven input capture, while the interfaces (162, 163) enable process monitoring, bidirectional communication with external control systems—including human operated or automated control interfaces and industrial integration. [0024] Collectively, modules (101-150) constitute the system (100) for multimodal acquisition, alignment, interpretation, and real-time manufacturing cost calculation functionality deployable across all platforms (160-163). [0024] Collectively, modules (101-150) constitute the system (100) for multimodal acquisition, alignment, interpretation, and real-time manufacturing cost calculation functionality deployable across all platforms (160-163).

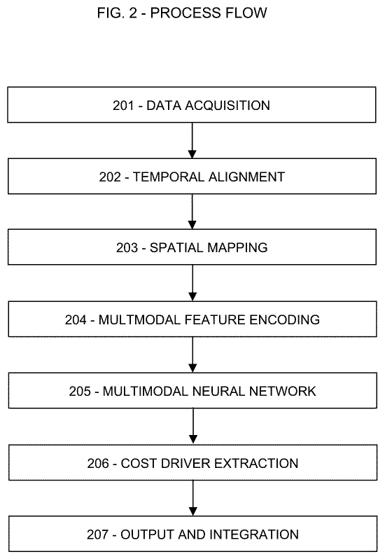

### DETAILED DESCRIPTION OF FIG. 2

### Process Flow

In one embodiment FIG. 2 schematically illustrates the process flow (200) of the system (100) for autonomous, real-time manufacturing-cost calculation. The process comprises sequential stages for multimodal data acquisition (201), temporal alignment (202), spatial mapping (203), multimodal feature encoding (204), neural-network processing (205), cost-driver extraction (206), and output-and-integration (207). Each stage corresponds to a functional module of the system architecture shown in FIG. 1A. [0026] In the data-acquisition stage (201), multimodal raw input is captured through the input-and-acquisition module (101), which includes cameras, microphones, inertial-measurement units (IMU), and environmental and material sensors. Visual, acoustic, and physical signals representing the object or process environment are recorded in parallel. The temporal-alignment stage (202) synchronizes the multimodal data streams using timestamp correlation and clock-domain adjustment. The spatial-mapping stage (203) registers sensor frames within a unified three-dimensional coordinate system by simultaneous localization and mapping (SLAM) supported by IMU calibration. This combined alignment establishes the geometric reference and spatial context necessary to associate each detected surface region or component with measurable attributes such as geometry, area, volume, and orientation. [0027] The spatially aligned data are subsequently processed in the multimodal feature-encoding stage (204). This stage converts the heterogeneous sensor information into structured feature vectors that represent geometric complexity and surface characteristics. Optical signals provide reflectivity and texture information, while acoustic and environmental data contribute additional context for process interpretation. These factors include, without limitation, material weight and density, geometric configuration, tolerances, cavity and tooling characteristics, surface-finish requirements, manufacturing methods, production volume, and environmental variations. The encoded feature set thus forms a normalized multimodal representation suitable for neural-network interpretation and cost-parameter generation. [0028] The encoded multimodal feature vectors are transmitted to the neural-network engine (205). This engine comprises modality-specific branches for visual, linguistic, and sensor data and a fusion mechanism that integrates the extracted features into a unified technical representation. The network applies trained correlations between geometry, material density, tolerance distribution, and process indicators to derive cost-relevant parameters. Each parameter is dynamically weighted according to statistical confidence derived from sensor precision and environmental stability. [0029] Within the neural-network engine (205), the fused feature representation enables extraction of dominant cost-driving factors. As previously described, these include material weight and density, geometric configuration, tolerances, cavity and tooling characteristics, surface-finish requirements, manufacturing methods, production volume, and environmental variations. The network performs continuous internal calibration using feedback from verified production data to maintain adaptive accuracy across varying operational conditions. [0030] The output-and-integration stage (207) presents the calculated manufacturing-cost results to the user in real time through mixed-reality (MR), virtual-reality (VR), or augmented-reality (AR) interfaces. The results are displayed as interactive overlays within the user's visual field, providing direct correlation between each observed component and its corresponding cost structure. The output and integration module (140) delivers the computed data via MR/VR/AR visualization, audible feedback, or structured digital export interfaces. This enables real-time cost transparency within the operator's visual or computational environment and completes the closed analytical loop from perception to feedback. [0031] The adaptive-learning module (150), as illustrated in FIG. 1, operates as a closed-loop optimization layer interfacing with the neural-network engine (205). It continuously analyzes deviations between predicted and verified manufacturing-cost results derived from stage (207) and adjusts the network's weighting parameters, confidence thresholds, and feature correlations accordingly. By incorporating validated production and environmental feedback, the adaptive-learning module refines the cost-calculation model over time, enhancing accuracy, robustness, and contextual sensitivity across diverse manufacturing conditions.

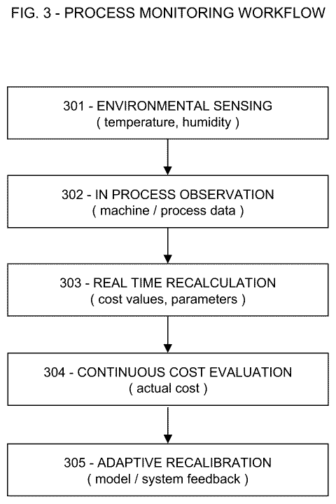

### DETAILED DESCRIPTION OF FIG. 3

### Process-Monitoring Workflow

In one embodiment FIG. 3 schematically illustrates a process-monitoring workflow (300) that represents a continuous, closed-loop sequence of process-integrated functional stages rather than independent hardware components. The numerical designations (301-305) correspond to operational functions executed by the system modules previously described in FIG. 1, including the environmental-sensing unit (109), inertial-measurement unit (107), position-and-tracking unit (108), sensor-data-processing branch (123), and adaptive-learning module (150). Each functional stage in the workflow (300) contributes to continuous process-level monitoring, real-time recalculation of production costs, and adaptive synchronization between observed physical conditions and digital cost computation. [0033] The environmental-sensing stage (301) measures ambient and material parameters including temperature, humidity, and particulate concentration to capture environmental influences affecting the observed process or equipment. The measurements are acquired through the environmental-sensing unit (109) and processed within the sensor-data-processing branch (123) of the neural-network engine (120). These continuously updated values provide contextual input for adaptive recalibration and ensure the cost-calculation engine operates in correlation with actual environmental dynamics. [0034] An in-process observation stage (302) captures live data from manufacturing equipment and process lines, including machine status, cycle times, process stability, and quality-related variations. The in-process observation stage (302) utilizes the position-and-tracking unit (108) together with the inertial-measurement unit (107) to maintain synchronized motion and positional awareness. The captured data enable the system to detect deviations in geometric alignment or material flow that influence production cost and performance. [0035] A real-time recalculation stage (303) continuously updates cost values and internal parameters when new sensor data are received from stages (301) and (302). The recalculation module incorporates changing conditions in material usage, machine efficiency, and process behavior. This mechanism ensures sustained cost accuracy under dynamically varying manufacturing environments and provides immediate numerical correction of previously estimated cost vectors.

A continuous cost-evaluation stage (304) validates the recalculated outputs by comparing them with measured manufacturing costs under observed conditions. The cost-evaluation stage maintains correlation between predicted and actual cost behavior and contributes to adaptive learning by forwarding confirmed deviations and convergence patterns into the adaptive-learning module (150) of FIG. 1. This feedback strengthens the network's predictive integrity and long-term calibration.

An adaptive-recalibration stage (305) adjusts neural-network parameters and associated weighting functions when deviations exceed predefined thresholds. The recalibration stage provides real-time feedback to the adaptive-learning module (150), refining correlation weights, confidence levels, and feature-fusion parameters in the neural-network engine (205). The recalibration process operates autonomously and on demand, ensuring continuous system fidelity without interrupting the cost-monitoring workflow.

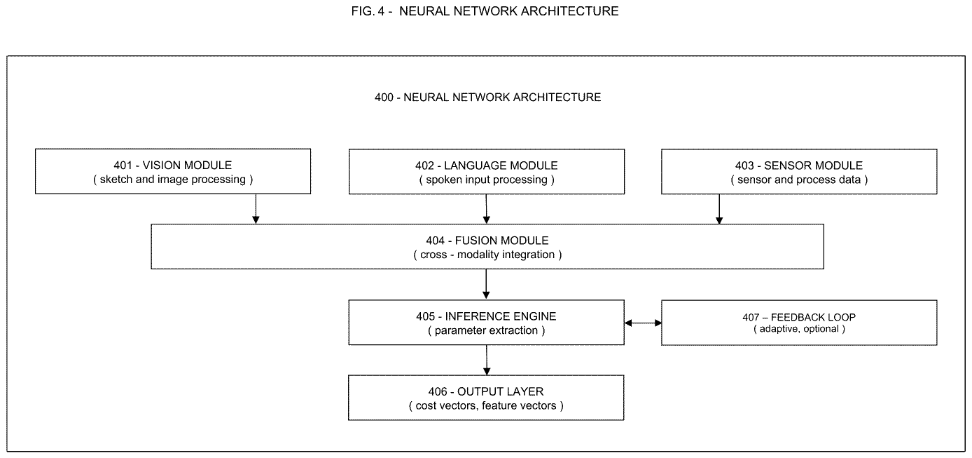

### DETAILED DESCRIPTION OF FIG. 4

### Neural-Network Architecture

In one embodiment, FIG. 4 illustrates the neural-network architecture (400). It comprises a vision module (401), a language module (402), a sensor module (403), a fusion module (404), an inference engine (405), an output layer (406), and an optional feedback loop (407). [0039] The vision module (401) processes visual inputs including sketches and images. In a preferred embodiment, the vision module (401) interprets hand-drawn sketches or contour outlines and derives geometric features such as length, diameter, and surface area, enabling direct extraction of cost-relevant geometry. [0040] The language module (402) processes spoken technical descriptions and associated linguistic input. In a preferred embodiment, the language module (402) accepts quantitative descriptors such as dimensions in millimeters, weights in grams, tolerance specifications, and other physical units, thereby linking linguistic input to measurable cost parameters. [0041] The sensor module (403) processes sensor-derived and process-related data. In a preferred embodiment, the sensor module (403) receives measurements from inertial, temperature, or reflectance sensors and derives material density, process conditions, and environmental influences, providing technical parameters for manufacturing cost calculation. [0042] In an alternative embodiment, the modules (401-403) operate in cross-functional combination, wherein information from the vision, language, and sensor modules is jointly processed to improve accuracy and robustness of parameter extraction. [0043] The fusion module (404) integrates outputs of the modality-specific modules (401-403) to form a unified representation. The inference engine (405) processes this representation to extract cost-relevant parameters including, without limitation, material weight and density, geometry, tolerances, cavity configuration, manufacturing method, production volume, labor factors, and environmental conditions. The feedback loop (407) enables online weight adjustment during active inference cycles, allowing the neural-network parameters to adapt in real time to variations in input or environmental deviations. Collectively, modules (401-407) operate as an integrated inference architecture that transforms multimodal input into cost-relevant output parameters through sequential feature extraction, fusion, and adaptive learning.

1. A system (100) configured to execute autonomous, real-time manufacturing-cost calculation, comprising: [symbol]
calculated cost information as interactive overlays within the operator's field of view. [symbol]
suitable for integration with enterprise, manufacturing, financial, or lifecycle-management software systems, including but not limited to ERP and MES platforms and analytical information systems.
and body-mounted displays (160,161), robot-integrated, or drone-mounted interfaces (162,163) providing visual or auditory cost-calculation feedback to the operator or control system.

[symbol]

11. A method for autonomous, real-time manufacturing-cost calculation, comprising:
capturing multimodal input including visual sketches, spoken technical descriptions, gestures, and sensor-derived signals;
temporally and spatially aligning the input data into a shared coordinate frame;
processing the aligned data by a multimodal neural network comprising vision, language, and sensor modules;
fusing the modality-specific data to form a unified technical representation;
extracting cost-relevant parameters including geometry, material properties, tolerances, manufacturing method, and production volume;
and calculating and outputting real-time manufacturing-cost results.

12. The method of claim 11, further comprising adapting the cost calculation based on environmental or process deviations detected during manufacturing.

13. The method of claim 11, wherein the multimodal neural network performs cross-modality learning to improve accuracy of parameter extraction and inference.

14. The method of claim 11, wherein the cost results are displayed as mixed-reality (MR), virtual-reality (VR), or augmented-reality (AR) overlays to the user in real time.

15. The method of claim 11, wherein the extracted parameters include process-related factors such as machine status, cycle time, and quality variations derived from sensor data.

16. The method of claim 11, further comprising continuously monitoring process data during manufacturing and triggering cost recalculation upon detection of significant deviations or updated input conditions.

17. The method of claim 11, wherein the neural network applies online weight adjustment through a feedback loop (407) to dynamically adapt inference precision during active manufacturing operations.

18. The method of claim 11, wherein multimodal data are captured through wearable, mounted, or embedded devices including head-mounted displays (HMD), body-mounted displays (BMD), robot-integrated systems, or drone-mounted systems.

19. The method of claim 11, further comprising generating structured cost-data outputs for integration into enterprise resource planning (ERP) or product lifecycle management (PLM) systems, where such systems are available.

20. A computer program comprising instructions which, when executed on a processor or computing device, cause the device to perform the method steps of any of claims 11-19,
including capturing multimodal input, aligning and processing data through a multimodal neural network, extracting cost-relevant parameters,
and generating real-time manufacturing-cost outputs in visual, auditory, or structured digital form.

21. A non-transitory computer-readable medium storing the program according to claim 20,
wherein the medium contains executable instructions configured to enable autonomous, real-time manufacturing-cost calculation independent of pre-existing structured datasets, cost databases, or CAD/BOM models.
